(19) United States
(12) Patent Application Publication
(10) Pub. No.: US 2007/0135124 A1
(43) Pub. Date: Jun. 14, 2007

(54) Method and system of multiple wireless HPLMN

(76) Inventors: Christopher J. Davolos, Warrenville, IL (US); Alex I. Moukalled, Naperville, IL (US); Daisy Feng-Mei Su, Naperville, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/301,585

(22) Filed: Dec. 13, 2005

(51) Int. Cl. H04Q 7/20

(52) U.S. Cl. 455/435.1; 455/433

(57) ABSTRACT

A method in one example has the steps of: registering a mobile terminal through a first RAN; receiving by a core network a first request from the mobile terminal via the first RAN and comparing a the HPLMN code of the IMSI associated with the first request with stored HPLMN codes in the core network; identifying, when a match is found between the HPLMN code of the IMSI and a respective stored HPLMN code in the core network, the mobile terminal as a home subscriber; registering the mobile terminal again through a second RAN when the mobile terminal is in the second RAN radio range; receiving by the core network a second request from the mobile terminal via the second RAN and comparing the HPLMN code of the IMSI associated with the second request with the stored HPLMN codes in the core network; regardless of the first and second HPLMN codes of the first and second RANs being different; and identifying, when a match is found between the HPLMN code of the IMSI and a further respective stored HPLMN code in the core network, the mobile terminal as a home subscriber.

### TECHNICAL FIELD

The invention relates generally to telecommunication networks, and more particularly to a telecommunications network that allows user equipment to obtain wireless services through multiple HPLMN (Home Public Land Mobile Network) codes.

### BACKGROUND

Wireless and wired communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA), Code Division Multiple Access (CDMA), or Wideband Code Division Multiple Access (WCDMA). Wireless phones are now also capable of connecting to the Internet, for example, and sending and receiving data. Some cellular phones, for example, are also configured for calls using voice over Internet protocol (VoIP).

Currently, a wireless operator is assigned with a paired MCC (mobile country code)+MNC (mobile network code) as the HPLMN code. Through mergers or other reasons, it is possible that the wireless operator can now have more than one HPLMN code in the network. The HPLMN code is important in the wireless network to identify if the user equipment is a home subscriber or roamer. In order to distinguish the actual home subscriber from the roamer, the wireless network or the user equipment needs to be able to recognize the multiple HPLMN.

Currently, there are a couple of solutions to enable the multiple HPLMN either on a radio access network or the user equipment. One method is to allow the radio access network to broadcast all possible HPLMN codes on any given single channel so that all user equipment can be recognized as homers if a matched HPLMN is found in its IMSI (International Mobile Station Identifier). With this method, both the radio access network and the core network must be changed. Another method is to allow the user equipment to have multiple HPLMN codes stored in its SIM (Subscriber Identity Module). If one of the stored HPLMN codes used in the IMSI matches one of the broadcasts on the radio channel, the user equipment will then be identified as a homer.

However, such current implementations require that either all the radio access networks and core networks be changed to send multiple HPLMN codes in one channel or that all user equipment be changed to store multiple HPLMN codes, Each of these implementations are costly and require significant resources to maintain.

Thus there is a need in the art for an improved and cost effective system that allows user equipment to obtain wireless services through multiple HPLMN codes.

### SUMMARY

One implementation encompasses an apparatus. This apparatus may comprise: a mobile terminal; a plurality of radio access networks (RAN); the mobile terminal, when using a first RAN of the plurality of RANs, having a first HPLMN code, and, when using a second RAN of the plurality of RANs, having a second HPLMN code, the first and second HPLMN codes being different; at least one core network operatively coupled to each of the radio access networks; the at least one core network having at least a database; and the database having stored HPLMN codes, respective stored HPLMN codes corresponding to the first and second HPLAN codes of the mobile terminal.

One implementation encompasses a method. This embodiment of the method may comprise: registering a mobile terminal through a first RAN; receiving by a core network a first request from the mobile terminal via the first RAN and comparing a the HPLMN code of the IMSI associated with the first request with stored HPLMN codes in the core network; identifying, when a match is found between the HPLMN code of the IMSI and a respective stored HPLMN code in the core network, the mobile terminal as a home subscriber; registering the mobile terminal again through a second RAN when the mobile terminal is in the second RAN radio range; receiving by the core network a second request from the mobile terminal via the second RAN and comparing the HPLMN code of the IMSI associated with the second request with the stored HPLMN codes in the core network; regardless of the first and second HPLMN codes of the first and second RANs being different; and identifying, when a match is found between the HPLMN code of the IMSI and a further respective stored HPLMN code in the core network, the mobile terminal as a home subscriber.

### DESCRIPTION OF THE DRAWINGS

Features of exemplary implementations will become apparent from the description, the claims, and the accompanying drawings in which:

FIG. 1 is an embodiment in a telecommunication network according to the present method and apparatus;

FIG. 2 is another embodiment in a telecommunication network according to the present method and apparatus; and

FIG. 3 is a flowchart depicting an embodiment according to the present method.

FIG. 4 is a flowchart depicting another embodiment according to the present method.

### DETAILED DESCRIPTION

The use of mobile station identifiers in wireless communication is widespread for registration, authentication, SMS (short message service), and other call processing and billing purposes. With the proliferation of mobile communications devices throughout the world, efforts have been made to standardize the mobile station identifiers so that a mobile station can be used in many different countries, provided it is capable of interconnecting with the type of service (e.g., TDMA, CDMA, WCDMA) offered. To this end, ITU-T E.212 43 recommends an international identification plan for land mobile stations and offers a recommendation to establish principles for allocating an International Mobile Station Identity (IMSI) to mobile stations. The idea is to enable mobile stations to roam among public land mobile networks located in different countries by adherence to an international identification plan with a unique international identification for each mobile station.

Part of the IMSI consists of the Mobile Country Code which is the part of the mobile station identifier which uniquely identifies the country of domicile of the mobile station. It is the first part of an IMSI designation and is 3 digits long. Mobile Network Code, which uniquely identifies the home network of the mobile station, is the second part of an IMSI designation and follows the MCC and is 1 to 3 digits long. The HPLMN code refers to the combination of the country code and the network code.

There are now circumstances where a mobile terminal, such as a cell phone, may have more than one IMSI. For example, there may be a merger of two telecommunication companies. Now, for example, a mobile terminal which was a home subscriber for one of the companies is now a home subscriber for both companies. When calls are handled by other companies, the mobile terminal is considered to be a roamer.

The mobile terminal is a home subscriber as long as the mobile terminal is connected via a radio access network of the plurality of radio access networks to the core network which is the home network. The mobile terminal is a home subscriber, not dependent upon its location, but because of the logical link to the home network.

In the phone number of the mobile terminal the first six digits comprises the country code and the network code. This information may be used it to identify the mobile terminal as a home subscriber to each of the two companies. The mobile terminal may communicate with a core network via a radio access network. The core network may be either a packet data core network or a switching core network. The switching core network may be the traditional voice network, and the packet data core network may be a network, such as the Internet. Typically, a plurality of radio access networks are connected to each of the core networks.

The switching core network and the packet data core network may be separate networks. For example, the switching core network may have a mobile switching center for handling traditional voice calls, and the packet data core network may have a packet data controller for handling data transfers and VoIP calls. It is to be understood that a company may have, for example, a plurality of packet data core networks and all of these packet data core networks for a particular company would be a home network for a mobile terminal that is a subscriber and registered with this company.

A wireless network system consists of several logical network elements, each of which has a well-defined functionality. A radio access network handles all radio related functionality. A core network is responsible for switching and routing calls, as well as for handling the data connection to external networks. A user's mobile terminal interfaces to the network via the radio interface.

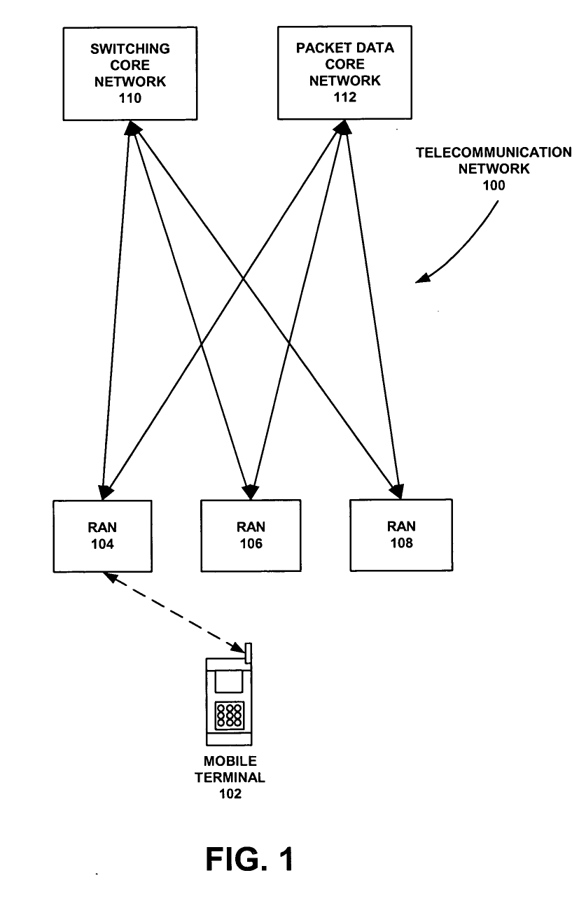

FIG. 1 depicts a wireless telecommunication network 100 that may have a plurality of radio access networks 104, 106, 108 operatively coupled to a core network 110, 112. The core network may be a switching core network 110 and/or a packet data core network 112. Each of the RANs 104, 106, 108 may be coupled to each of the core networks 110, 112 as depicted in FIG. 1. It is to be understood that there may be any number of core networks of each of various types.

A mobile station, such as, mobile terminal 102, may be assigned with an IMSI whose MCC+MNC matches the MCC+MNC of the RAN 104. In this example RAN 104 may have a MCC+MNC that is different than the MCC+MNC of RAN 106. In order for the mobile terminal 102 to be considered a homer, the core network, such as packet data core network 112, defines the MCC+MNC of RAN 104 and the MCC+MNC of RAN 106 as the HPLMN. This functionality allows the mobile terminal 102 to be a homer in each of RAN 104 and RAN 106.

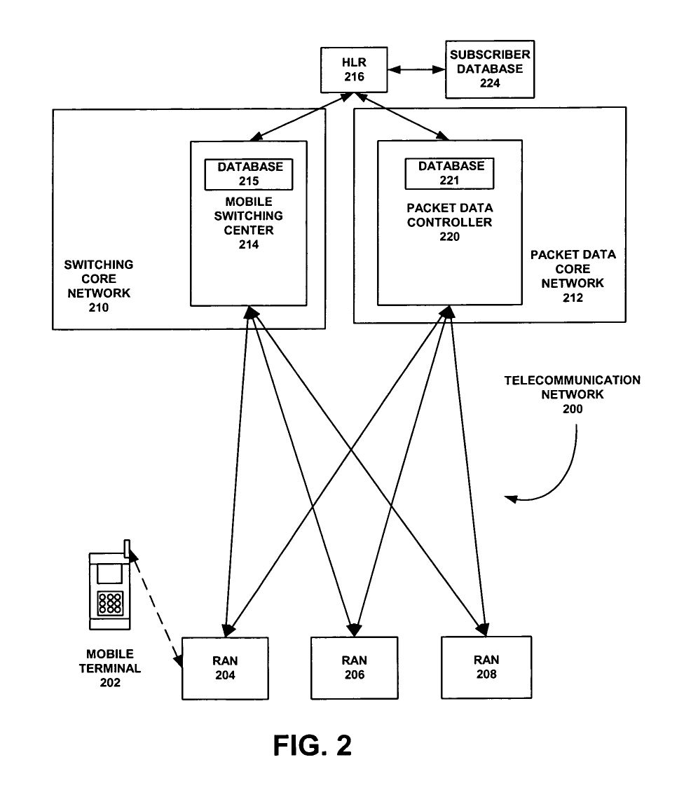

FIG. 2 depicts a wireless telecommunication network 200 that may have a plurality of radio access networks 104, 106, 108 operatively coupled to core networks 210, 212. As described above, the core network may be a switching core network 210 and/or a packet data core network 212. The switching core network 210 may have a mobile switching center 214 with a database 215. Similarly, the packet data core network 210 may have a packet data controller 220 with a database 221. Each of the mobile switching center 214 and the packet data controller 220 is operatively coupled to a home location register 216, which has a subscriber database 224.

The home location register 216 may store information in the subscriber database 215 about the services to which the mobile terminal 202 may have access. Similarly, The databases 215, 224 may store a plurality of MCC+MNC identification codes corresponding to mobile terminals that are registered as home subscribers in the respective core networks.

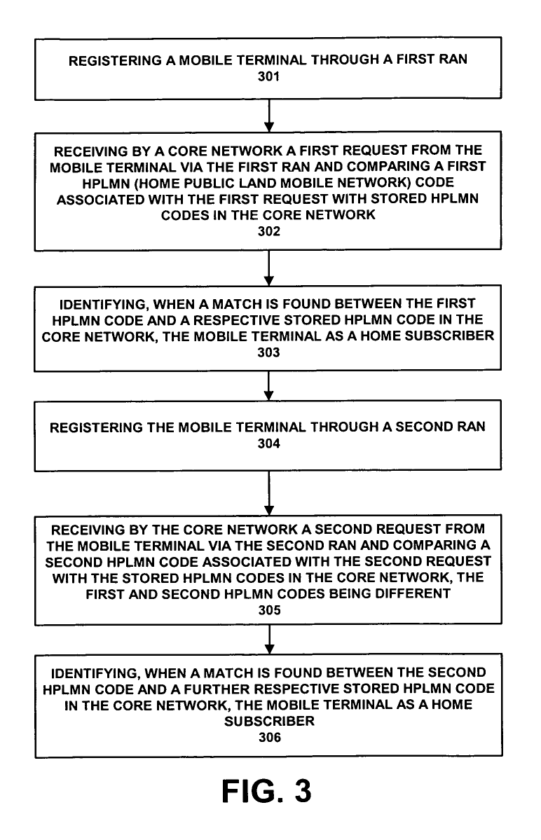

FIG. 3 depicts one embodiment according to the present method. This embodiment may have the following steps: registering a mobile terminal through a first RAN (Radio Access Network) (301); receiving by a core network a first request from the mobile terminal via the first RAN and comparing a first HPLMN (Home Public Land Mobile Network) code associated with the first request with stored HPLMN codes in the core network (302); identifying, when a match is found between the first HPLMN code and a respective stored HPLMN code in the core network, the mobile terminal as a home subscriber (303); registering the mobile terminal through a second RAN (304); receiving by the core network a second request from the mobile terminal via the second RAN and comparing a second HPLMN code associated with the second request with the stored HPLMN codes in the core network, the first and second HPLMN codes being different (305); and identifying, when a match is found between the second HPLMN code and a further respective stored HPLMN code in the core network, the mobile terminal as a home subscriber (306).

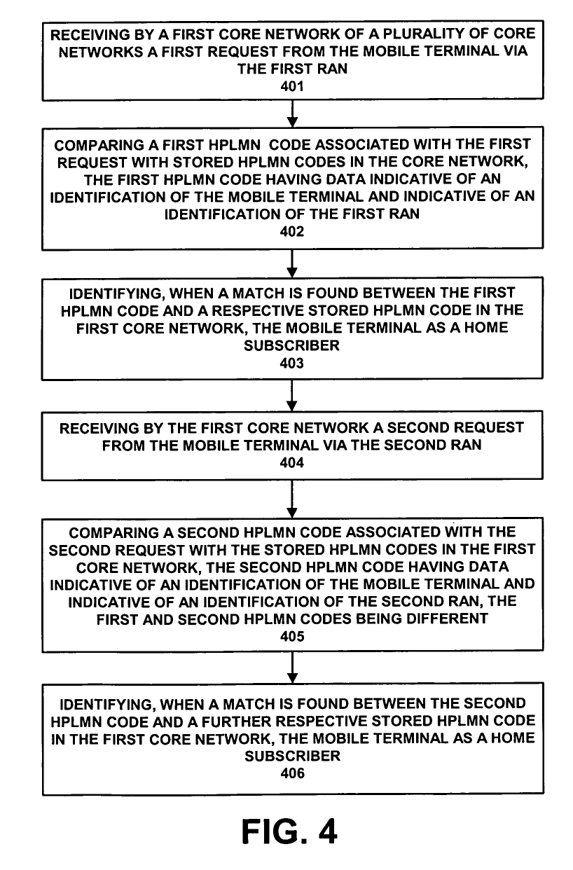

FIG. 4 depicts another embodiment according to the present method. This embodiment may have the following steps: receiving by a first core network of a plurality of core networks a first request from the mobile terminal via the first RAN (401); comparing a first HPLMN (Home Public Land Mobile Network) code associated with the first request with stored HPLMN codes in the core network, the first HPLMN code having data indicative of an identification of the mobile terminal and indicative of an identification of the first RAN (402); identifying, when a match is found between the first HPLMN code and a respective stored HPLMN code in the first core network, the mobile terminal as a home subscriber (403); receiving by the first core network a second request from the mobile terminal via the second RAN (404); comparing a second HPLMN code associated with the second request with the stored HPLMN codes in the first core network, the second HPLMN code having data indicative of an identification of the mobile terminal and indicative of an identification of the second RAN, the first and second HPLMN codes being different (405); and identifying, when a match is found between the second HPLMN code and a further respective stored HPLMN code in the first core network, the mobile terminal as a home subscriber (406).

As explained above, the first core network may be a switching core network and/or a packet data core network. The IMSI may comprise at least a mobile country code and a mobile network code, and each stored HPLMN code may comprise at least a mobile country code and a mobile network code of a mobile terminal that is a home subscriber. The mobile country code and the mobile network code of the IMSI may be compared with the mobile country codes and the mobile network codes of the stored HPLMN codes.

The present apparatus in one example may comprise a plurality of components such as one or more of electronic components, hardware components, and computer software components. A number of such components may be combined or divided in the apparatus.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A method comprising:
registering a mobile terminal through a first RAN (Radio Access Network);
receiving by a core network a first request from the mobile terminal via the first RAN and comparing a first HPLMN (Home Public Land Mobile Network) code associated with the first request with stored HPLMN codes in the core network;
identifying, when a match is found between the first HPLMN code and a respective stored HPLMN code in the core network, the mobile terminal as a home subscriber;
registering the mobile terminal through a second RAN;
receiving by the core network a second request from the mobile terminal via the second RAN and comparing a second HPLMN code associated with the second request with the stored HPLMN codes in the core network;
the first and second HPLMN codes being different; and
identifying, when a match is found between the second HPLMN code and a further respective stored HPLMN code in the core network, the mobile terminal as a home subscriber.

2. The method according to claim 1, wherein the core network is a switching core network.

3. The method according to claim 1, wherein the core network is a packet data core network.

4. The method according to claim 1, wherein an HPLMN code comprises at least a mobile country code and a mobile network code.

5. The method according to claim 4, wherein stored HPLMN codes for a mobile terminal that is a home subscriber comprise multiple combinations of different mobile country codes and mobile network codes for the mobile terminal.

6. The method according to claim 5, wherein the method further comprises comparing the mobile country code and the mobile network code of a current HPLMN code for the mobile terminal with each of the multiple combinations of different mobile country codes and mobile network codes of the stored HPLMN codes.

7. A method comprising:
receiving by a first core network of a plurality of core networks a first request from the mobile terminal via the first RAN;
comparing a first HPLMN (Home Public Land Mobile Network) code associated with the first request with stored HPLMN codes in the core network, the first HPLMN code having data indicative of an identification of the mobile terminal and indicative of an identification of the first RAN;
identifying, when a match is found between the first HPLMN code and a respective stored HPLMN code in the first core network, the mobile terminal as a home subscriber;
receiving by the first core network a second request from the mobile terminal via the second RAN;
comparing a second HPLMN code associated with the second request with the stored HPLMN codes in the first core network, the second HPLMN code having data indicative of an identification of the mobile terminal and indicative of an identification of the second RAN;
the first and second HPLMN codes being different; and
identifying, when a match is found between the second HPLMN code and a further respective stored HPLMN code in the first core network, the mobile terminal as a home subscriber.

8. The method according to claim 7, wherein the first core network is a switching core network.

9. The method according to claim 7, wherein the first core network is a packet data core network.

10. The method according to claim 7, wherein each HPLMN comprises at least a mobile country code and a mobile network code.

11. The method according to claim 10, wherein stored HPLMN codes for a mobile terminal that is a home subscriber comprise multiple combinations of different mobile country codes and mobile network codes for the mobile terminal.

12. The method according to claim 11, wherein the method further comprises comparing the mobile country code and the mobile network code of a current HPLMN code for the mobile terminal with each of the multiple combinations of different mobile country codes and mobile network codes of the stored HPLMN codes.

13. An apparatus, comprising:
a mobile terminal;
a plurality of radio access networks (RAN);
the mobile terminal, when using a first RAN of the plurality of RANs, having a first HPLMN code, and, when using a second RAN of the plurality of RANs, having a second HPLMN code, the first and second HPLMN codes being different;
at least one core network operatively coupled to each of the radio access networks;
the at least one core network having at least a database; and
the database having stored HPLMN codes, respective stored HPLMN codes corresponding to the first and second HPLAN codes of the mobile terminal.

14. The apparatus according to claim 13, wherein the first HPLMN code has data indicative of an identification of the mobile terminal and indicative of an identification of the first RAN, and wherein the second HPLMN code having data indicative of an identification of the mobile terminal and indicative of an identification of the second RAN.

15. The apparatus according to claim 13, wherein the core network is a switching core network.

16. The apparatus according to claim 13, wherein the core network is a packet data core network.

17. The apparatus according to claim 13, wherein the first HPLMN code comprises at least a mobile country code and a mobile network code of the first RAN, and wherein the second HPLMN code comprises at least a mobile country code and a mobile network code of the second RAN.

18. The apparatus according to claim 14, wherein stored HPLMN codes for the mobile terminal that is a home subscriber comprise multiple combinations of different mobile country codes and mobile network codes for the mobile terminal, and wherein the apparatus further has functionality for comparing the mobile country code and the mobile network code of a current HPLMN code for the mobile terminal with each of the multiple combinations of different mobile country codes and mobile network codes of the stored HPLMN codes.

19. An apparatus, comprising:
a mobile terminal;
a plurality of radio access networks (RAN);
the mobile terminal, when using a first RAN of the plurality of RANs, having a first HPLMN code, and, when using a second RAN of the plurality of RANs, having a second HPLMN code, the first and second HPLMN codes being different;
a plurality of core networks, each of the core networks operatively coupled to each of the radio access networks;
each of the core networks having a respective database;
the respective database having stored HPLMN codes, respective stored HPLMN codes corresponding to the first and second HPLAN codes of the mobile terminal;
the first HPLMN code having a mobile country code and a mobile network code of the first RAN, and the second HPLMN code having a mobile country code and a mobile network code of the second RAN;
stored HPLMN codes for a mobile terminal that is a home subscriber having multiple combinations of different mobile country codes and mobile network codes for the mobile terminal; and
functionality for comparing the mobile country code and the mobile network code of a current HPLMN code for the mobile terminal with each of the multiple combinations of different mobile country codes and mobile network codes of the stored HPLMN codes.

20. The apparatus according to claim 19, wherein one of the plurality of core networks is a switching core network.

21. The apparatus according to claim 19, wherein one of the plurality of core networks is a packet data core network.
